(19) United States
(12) Patent Application Publication
(10) Pub. No.: US 2026/0334747 A1
(43) Pub. Date: Oct. 29, 2026

(54) CLEANING MEMBER DRYING MODULE, CLEANING BASE STATION, AND CLEANING SYSTEM

(71) Applicant: Dreame Innovation Technology (Suzhou) Co., Ltd., Suzhou (CN)

(72) Inventors: Zhusheng HUANG, Suzhou (CN); Xuan Yang, Suzhou (CN); Hao Xu, Suzhou (CN); Jianfeng Hu, Suzhou (CN)

(21) Appl. No.: 19/720,480

(22) Filed: Jun. 25, 2026

Related U.S. Application Data
(63) Continuation of application No. PCT/CN2025/140915, filed on Dec. 8, 2025.

(30) Foreign Application Priority Data
Jan. 22, 2025 (CN) 202520154459.0

(51) Int. Cl. A47L 11/40; F26B 9/00; F26B 9/06; F26B 21/00

(52) U.S. Cl. CPC A47L 11/4091; F26B 9/003; F26B 9/06; F26B 21/001; A47L 2201/028

(57) ABSTRACT

A cleaning member drying module, a cleaning base station, and a cleaning system, where, the cleaning member drying module includes: a housing, where a diversion air duct is provided inside the housing, a plurality of accommodating spaces in communication with the diversion air duct are provided on the housing, and the accommodating spaces are configured to receive cleaning members of a cleaning device; an airflow driving member disposed inside the housing, the airflow driving member having a fan air duct in communication with the diversion air duct; and a heater disposed upstream of the accommodating spaces along an airflow path, the heater being configured to heat an airflow passing therethrough to form a drying airflow for drying the cleaning members.

### CROSS-REFERENCE TO RELATED DISCLOSURES

The present application is a continuation of International Application No. PCT/CN 2025/140915, filed on Dec. 8, 2025, which claims priority to Chinese Patent Application No. 202520154459.0, filed with the China National Intellectual Property Administration on Jan. 22, 2025 and entitled “CLEANING MEMBER DRYING MODULE, CLEANING BASE STATION, AND CLEANING SYSTEM”. The disclosures of the aforementioned applications are hereby incorporated by reference in their entireties.

### TECHNICAL FIELD

The present application relates to the technical field of cleaning devices, and in particular, to a cleaning member drying module, a cleaning base station, and a cleaning system.

### BACKGROUND

With the continuous development of the smart home technology, automatic cleaning devices, such as floor sweepers or sweeping robots, have become essential tools for daily household cleaning. Such cleaning devices can autonomously clear up dust and stains from the floor and can also perform maintenance operations, such as charging and washing of cleaning members, by means of a cleaning base station.

The existing cleaning base stations can wash the cleaning members of the cleaning device in a washing tank and dry the washed cleaning members by a drying mechanism.

However, for cleaning devices configured with a plurality of sets of replaceable cleaning members, the existing cleaning base stations require a relatively long period to dry the plurality of sets of cleaning members, which in turn affects the drying efficiency of the cleaning base station.

### SUMMARY

The present application provides a cleaning member drying module, a cleaning base station, and a cleaning system. A plurality of sets of cleaning members can be dried simultaneously, which is conducive to improving the drying efficiency of the cleaning base station.

In a first aspect, the present application provides a cleaning member drying module for a cleaning base station, including: a housing, where a diversion air duct is provided inside the housing, a plurality of accommodating spaces in communication with the diversion air duct are provided on the housing, and the accommodating spaces are configured to receive cleaning members of a cleaning device; an airflow driving member disposed inside the housing, the airflow driving member having a fan air duct in communication with the diversion air duct; and a heater disposed upstream of the accommodating spaces along an airflow path, the heater being configured to heat an airflow passing therethrough to form a drying airflow for drying the cleaning members.

As such, by disposing the diversion air duct and the plurality of accommodating spaces in communication with the diversion air duct are provided inside the housing of the cleaning member drying module to accommodate a plurality of sets of cleaning members so as to enable batch drying of the plurality of sets of cleaning members, thereby effectively improving the drying efficiency. In addition, the plurality of accommodating spaces are provided, such that the plurality of sets of cleaning members can be dried in batch, thereby reducing the total number of drying operations of the cleaning base station, lowering the activation frequency of key components such as the airflow driving member and the heater, and thus extending the service life of the cleaning base station.

In a possible implementation, the housing includes: a mounting plate comprising a first surface and a second surface opposite each other along a thickness direction, part of the first surface being recessed toward the second surface to form a recess; and an air duct shell reversibly disposed in the recess, the diversion air duct being formed inside the air duct shell, and the accommodating spaces running through a side surface of the air duct shell along a thickness direction of the air duct shell to communicate with the diversion air duct, where a clearance opening for providing clearance for the accommodating spaces is provided in a bottom wall of the recess.

As such, the recess is formed in the mounting plate to provide a receiving space for the air duct shell, such that the air duct shell is reversibly disposed in the recess, thereby facilitating mounting of the air duct shell and the maintenance, service and other operations of an internal structure of the cleaning member drying module. The diversion air duct is formed inside the air duct shell, and the accommodating spaces run through the side surface of the air duct shell along the thickness direction of the air duct shell and are in communication with the diversion air duct, such that it is ensured that the drying airflow can smoothly flow through the diversion air duct into the accommodating spaces, thereby ensuring the drying effect for the plurality of sets of cleaning members.

In a possible implementation, a mounting groove is provided in the second surface of the mounting plate, the mounting groove and the recess being distributed along a first direction and spaced apart by a side wall of the recess. The airflow driving member is disposed in the mounting groove. An air passage opening is provided in a side wall of the recess facing the mounting groove, and the diversion air duct communicates with the fan air duct via the air passage opening.

As such, the mounting groove and the recess are spaced apart by the side wall of the recess, such that an independent receiving space may be provided for the airflow driving member, to prevent external interferences and ensure the stable operation of the airflow driving member. The air passage opening is provided to allow the diversion air duct communicates with the fan air duct, such that the airflow generated by the airflow driving member can smoothly enter the diversion air duct through the air passage opening and is then distributed to the accommodating spaces, providing a continuous and stable airflow for drying the cleaning members.

In a possible implementation, the air duct shell further includes: a base plate adapted to the recess in shape; and a partition plate fixedly disposed on a side of the base plate facing the recess, the partition plate and the base plate together defining the diversion air duct, the partition plate having a plurality of hollowed-out partition rings, and the partition rings defining the accommodating spaces in an enclosing manner.

As such, the base plate is configured to be adapted to the recess in shape such that the air duct shell may be stably and properly mounted in the recess, ensuring the stability of the air duct shell during operation, avoiding waggling, displacement, and the like caused by unstable mounting, which otherwise influences the normal airflow circulation inside the cleaning member drying module. The hollowed-out partition rings define the accommodating spaces in an enclosing manner, such that each accommodating space for receiving the cleaning member can be clearly delimited, ensuring that the cleaning members do not interfere with each other during the drying process and reducing the influences of an unstable airflow on the drying process.

In a possible implementation, along a second direction, a width of an inlet of the diversion air duct is greater than a width of an outlet of the fan air duct; and the airflow driving member further includes a diffusion nozzle, wherein the diffusion nozzle is disposed at the outlet of the fan air duct, the diffusion nozzle defines a diffusion air duct, and a flow area of the diffusion air duct gradually increases along a first direction and a direction from the mounting groove toward the recess.

As such, the width of the inlet of the diversion air duct is greater than the width of the outlet of the fan air duct, and the diffusion nozzle is provided at the outlet of the fan air duct to form a diffusion air duct, such that the flow area of the airflow in the direction from the mounting groove toward the recess can be gradually increased, thereby effectively reducing the airflow velocity and increasing the contact time between the airflow and the cleaning members, and thus ensuring more uniform distribution of the airflow to the cleaning member in each accommodating space, which improves the drying efficiency and uniformity. Furthermore, a larger width of the inlet of the diversion air duct is conducive to reducing pressure loss during airflow entry, improving the airflow transmission efficiency.

In a possible implementation, the heater is disposed in at least one of the fan air duct, the diversion air duct, the diffusion air duct and the accommodating spaces.

As such, the heaters are arranged at key nodes along the airflow path, and effective transfer and uniform distribution of thermal energy can be ensured, thereby achieving efficient heating of the airflow.

In a possible implementation, the heater is fixed to at least one of the mounting plate, the air duct shell, the partition plate and the diffusion nozzle.

As such, directly fixing the heaters to key structural components can not only ensure the stability and durability of the heater, but also optimize the heat conduction path, enabling the heat to be transferred into the airflow more quickly and uniformly.

In a possible implementation, the heater is disposed at least on a bottom wall of the accommodating space and is adapted to be in contact with the cleaning member.

As such, the heater is disposed on the bottom wall of the accommodating space and is in contact with the cleaning member such that heat can be directly and efficiently conducted to the surface of the cleaning member, thereby accelerating moisture evaporation and shortening the drying time. The direct contact heating not only avoids the problem of non-uniform temperature but also provides consistent heat input to different portions of the cleaning member, thereby ensuring a comprehensive and uniform drying effect.

In a possible implementation, the heater is at least one of a heater tube, a heater film, and a heater wire.

As such, the flexibility of the cleaning member drying module can be enhanced. By selecting different types of heaters, the thermal energy distribution can be optimized according to the requirements of specific application scenarios, ensuring that different portions of the cleaning member can receive sufficient and uniform heat input.

In a possible implementation, an assembly clearance between a peripheral wall of each cleaning member and an inner side wall of each accommodating space is greater than or equal to 3 mm.

As such, a rational assembly clearance is provided to ensure that the airflow can circulate freely around the cleaning members, preventing airflow blockage or non-uniform distribution caused by a too small clearance, thereby increasing the coverage area and contact time of the airflow on the surface of the cleaning members and enhancing the drying effect. In addition, the above assembly clearance can also reduce friction between the cleaning members and the inner side walls of the accommodating spaces, thereby lowering the risk of wear of the cleaning members during placement or removal, and extending the service life of the cleaning members and the accommodating spaces.

In a possible implementation, the cleaning member includes a cleaning cloth.

As such, compared with other types of cleaning members, the cleaning cloth is easier to wash and dry, and can restore to a usable state within a shorter period of time, thereby shortening the overall cleaning cycle.

In a possible implementation, the air duct shell is movable relative to the mounting plate to open or close the diversion air duct.

As such, the air duct shell is designed to be movable relative to the mounting plate such that the operational flexibility and maintenance convenience of the cleaning member drying module can be enhanced. The air duct shell is movable relative to the mounting plate, such that a user or the cleaning base station can easily open or close the diversion air duct according to actual requirements, thereby achieving control over the airflow path.

In some embodiments, the housing has a ventilation opening, the airflow driving member is disposed upstream of the accommodating spaces along an airflow path, and the airflow driving member blows an airflow introduced into the fan air duct from the ventilation opening, through the diversion air duct toward the accommodating spaces for discharge.

As such, the airflow driving member may blow the airflow toward the accommodating spaces.

In some embodiments, the housing is provided with a ventilation opening, the airflow driving member is disposed downstream of the accommodating spaces along the airflow path, and the airflow driving member suctions the airflow introduced into the diversion air duct from the ventilation opening, through the accommodating spaces into the fan air duct for discharge.

As such, the airflow driving member may suction the airflow to the accommodating spaces.

In some embodiments, a rotating support member is disposed on a bottom wall of each of the accommodating spaces, the rotating support member being rotatable relative to the housing, and the rotating support member being configured to drive the cleaning member to rotate when the cleaning member is disposed in the accommodating spaces and is dried.

As such, during the drying process, the rotating support member drives the cleaning member to rotate, which is conducive to uniform heating of the cleaning member, thereby improving the drying efficiency and drying effect.

In a second aspect, the present application provides a cleaning base station, including: a base station body, where a cleaning chamber configured to clean a cleaning device is provided on one side of the base station body along a circumferential direction, and the base station body is further provided with a mounting space located on a peripheral side of the cleaning chamber; and the cleaning member drying module of any one of the above possible implementations, where a mounting plate of the cleaning member drying module is fixedly disposed in the mounting space, and an air duct shell of the cleaning member drying module is located on a side of the mounting plate facing away from the base station body.

As such, the cleaning member drying module is integrated into the base station body, thereby ensuring a compact and aesthetically pleasing structure of the cleaning base station. By means of the fixed position of the mounting plate, the cleaning member drying module can be closely combined with the base station body, enhancing the overall structural stability and facilitating maintenance and service. In addition, the air duct shell is located outside of the mounting plate. This may not only provide a smooth passage for the airflow, but also allow the air duct shell to move relative to the mounting plate, such that the user or the cleaning base station can open or close the diversion air duct, thereby optimizing the airflow path and simplifying the loading and unloading of the cleaning members.

In a possible implementation, the mounting space has an air outlet, and an area of an air inlet of the diversion air duct is greater than an area of the air outlet.

As such, a larger area of the air inlet is provided to ensure that the sufficient airflow can enter the diversion air duct, reducing pressure loss during airflow entry. The provision of a smaller area of the air outlet contributes to creating a pressure difference before the airflow is discharged, enabling the airflow to be more uniformly distributed during passage through the cleaning members and prolonging the residence time of the airflow within the accommodating spaces, thereby ensuring sufficient drying of the cleaning members.

In a third aspect, the present application provides a cleaning system, including: a cleaning device having removable cleaning members; and the above cleaning base station, the cleaning base station being configured to replace, wash, and dry the cleaning members of the cleaning device.

As such, this is conducive to achieving full-process management of washing, replacement and drying of the cleaning members, thereby simplifying the operation procedures for the user. The cleaning member drying module of the cleaning base station enables batch drying of the plurality of sets of cleaning members, effectively improving the drying efficiency. Batch drying of the plurality of sets of cleaning members can reduce the total number of drying operations of the cleaning base station, thereby reducing the maintenance frequency and cost of the cleaning system.

### BRIEF DESCRIPTION OF DRAWINGS

The drawings herein, which are incorporated into the description and form a part of the description, illustrate embodiments that conform to the present application and are used together with the description to explain the principles of the present application.

FIG. 1 is a first schematic structural diagram of a cleaning base station according to the present application.

FIG. 2 is a second schematic structural diagram of a cleaning base station according to the present application.

FIG. 3 is a first partial schematic structural diagram of a cleaning member drying module according to the present application.

FIG. 4 is a second partial schematic structural diagram of a cleaning member drying module according to the present application.

FIG. 5 is a first schematic structural diagram of a mounting plate of the cleaning member drying module according to the present application.

FIG. 6 is a second schematic structural diagram of a mounting plate of the cleaning member drying module according to the present application.

FIG. 7 is a first schematic structural diagram of an air duct shell of the cleaning member drying module according to the present application.

FIG. 8 is a cross-sectional view of the air duct shell of the cleaning member drying module according to the present application.

FIG. 9 is a schematic structural diagram of an airflow driving member of the cleaning member drying module according to the present application.

FIG. 10 is a schematic diagram of a cleaning system according to the present application.

### LIST OF REFERENCE SIGNS

1—Cleaning base station; 2—Cleaning member;
10—Cleaning member drying module;
110—Housing; 111—Diversion air duct; 112—Accommodating space;
113—Mounting plate; 1131—First surface; 1132—Second surface; 1132a-Mounting groove; 1133—Recess; 1133a—Clearance opening; 1133b—Air passage opening;
114—Air duct shell; 1141—Base plate; 1142—Partition plate; 1142a-Partition ring;
120—Airflow driving member; 121—Fan air duct; 122-Diffusion nozzle; 1221 Diffusion air duct;
130—Heater;
140—Rotating support member;
20—Base station body; 210—Cleaning chamber; 220—Air outlet;
100—Cleaning device; 200—Cleaning system.

The above figures illustrate specific embodiments of the present application, which are described in further detail below. These figures and textual descriptions are not intended to limit the scope of the concept of the present application in any way, but rather to illustrate the concept of the present application for a person skilled in the art with reference to specific embodiments.

### DESCRIPTION OF EMBODIMENTS

Exemplary embodiments are described in detail herein, examples of which are illustrated in the figures. Where the following descriptions refer to the figures, like reference numerals in different figures denote the same or similar elements, unless otherwise specified. The implementations described in the following exemplary embodiments do not represent all implementations consistent with the present application. Rather, the exemplary embodiments are merely examples of apparatuses and methods consistent with some aspects of the present application, as set forth in the appended claims.

As shown in the background section, the existing cleaning base stations can wash cleaning members in a washing tank and dry the washed cleaning members by means of a drying mechanism. However, for cleaning devices configured with a plurality of sets of replaceable cleaning members, the existing cleaning base stations require a relatively long period to dry the plurality of sets of cleaning members, which in turn affects the drying efficiency of the cleaning base station.

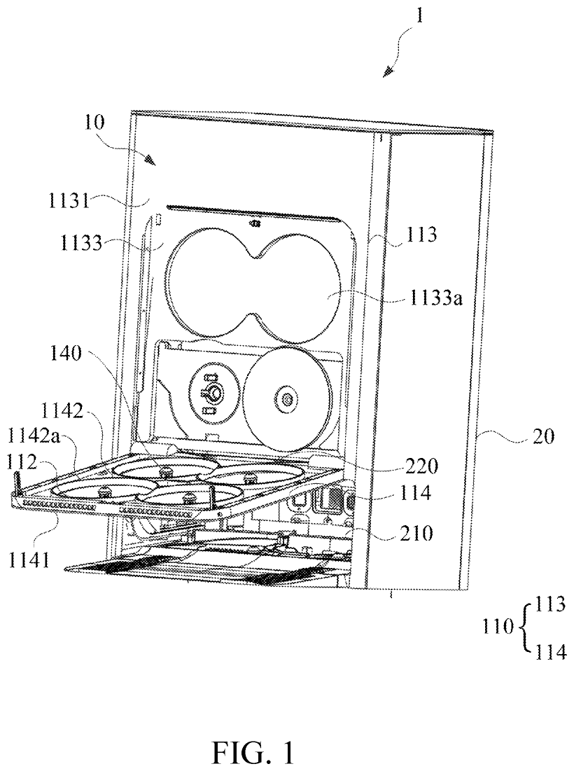

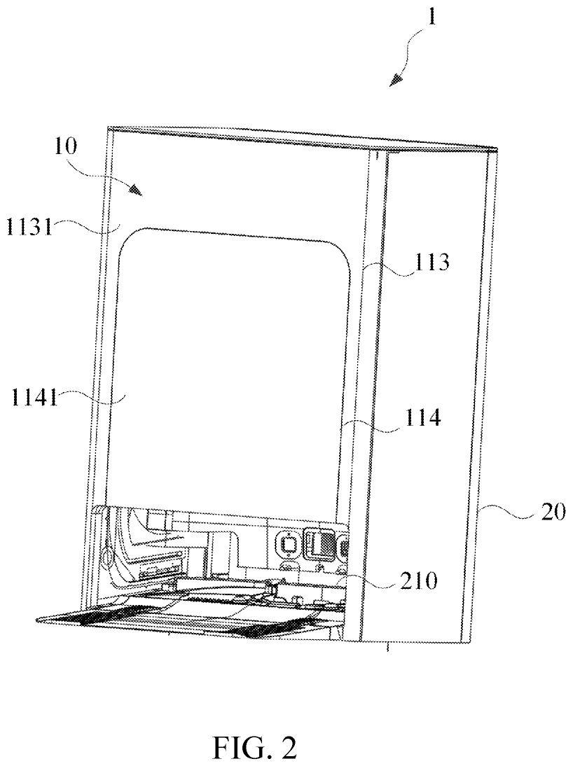

In view of this, the present application provides a cleaning member drying module 10 for a cleaning base station 1. Referring to FIGS. 1 and 2, the cleaning member drying module 10 includes a housing 110, an airflow driving member 120, and a heater 130.

The housing 110 serves as a housing structure of the cleaning member drying module 10 and may provide mechanical support and protection for internal components such as the airflow driving member 120 and the heater 130. The airflow driving member 120 may generate an airflow to provide necessary air circulation power throughout a drying process. The heater 130 may heat the airflow passing therethrough, such that the airflow becomes a drying airflow having a drying capability, thereby providing a heat source for removing moisture from cleaning members 2.

Referring to FIG. 8, a diversion air duct 111 and a plurality of accommodating spaces 112 are provided inside the housing 110. The accommodating spaces 112 are configured to accommodate the cleaning members 2 of a cleaning device 100. The plurality of accommodating spaces 112 may be independent of each other, such that the cleaning members 2 in the plurality of accommodating spaces 112 can receive the drying airflow without interfering with each other. The diversion air duct 111 may be in communication with the plurality of accommodating spaces 112. Furthermore, the diversion air duct 111 may provide a particular flow path for the airflow, such that the airflow may flow in a preset direction and way in the housing 110 so as to be delivered to the accommodating spaces 112, thereby enabling drying of the cleaning members 2.

In an implementation, the diversion air duct 111 may have a tree-branch structure. At a start end of the diversion air duct 111 is a relatively large main air duct, and the airflow generated by the airflow driving member 120 may first enter the main air duct. The main air duct may be branched into a plurality of branch air ducts in different directions, and a tail end of each branch air duct is in communication with a corresponding accommodating space 112. The number of the branch air ducts may be determined depending on the number of the accommodating spaces 112, to ensure that each accommodating space 112 is individually interfaced with a branch air duct. Alternatively, the branch air duct may have an annular branch structure. The diversion air duct 111 may have an overall annular layout, and the diversion air duct 111 may be disposed around the plurality of accommodating spaces 112 to form a closed annular main air duct. A plurality of branch air ducts may be disposed at different parts of the annular main air duct, and the branch air ducts may open to the accommodating spaces 112, respectively. In this way, the airflow may first circulate in the annular main air duct to achieve preliminary diffusion, and then enter the corresponding accommodating spaces 112 through the branch air ducts. Alternatively, the branch air duct may have a grid structure, a double-layer structure, a multi-layer nested structure, or the like. The specific structure of the branch air duct may be determined according to actual requirements, which is not limited in the present application.

Referring to FIGS. 1, 2, 3, and 4, the airflow driving member 120 may be disposed inside the housing 110. The airflow driving member 120 is provided with a fan air duct 121. The fan air duct 121 may be in communication with the diversion air duct 111, such that the airflow generated by the airflow driving member 120 enters the diversion air duct 111 through the fan air duct 121. To achieve drying of the cleaning members 2, the heater 130 may be disposed upstream of the accommodating spaces 112 along an airflow path. In this way, the heater 130 may heat the airflow passing therethrough to form a drying airflow for drying the cleaning members 2.

It may be understood that the diversion air duct 111 and the plurality of accommodating spaces 112 in communication with the diversion air duct 111 are provided inside the housing 110 of the cleaning member drying module 10 to accommodate a plurality of sets of cleaning members 2 so as to enable batch drying of the plurality of sets of cleaning members 2, thereby effectively improving the drying efficiency. In addition, the plurality of accommodating spaces 112 are provided, such that the plurality of sets of cleaning members 2 can be dried in batch, thereby reducing the total number of drying operations of the cleaning base station 1, lowering the activation frequency of key components such as the airflow driving member 120 and the heater 130, and thus extending the service life of the cleaning base station 1.

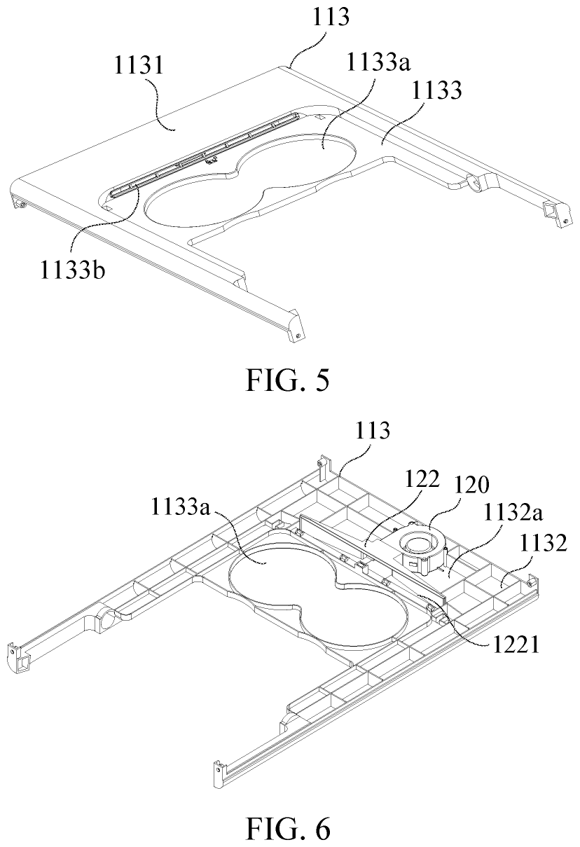

In a possible implementation, referring to FIGS. 1, 2, 3, 4, 5, and 6, the housing 110 includes a mounting plate 113 and an air duct shell 114. The mounting plate 113 includes a first surface 1131 and a second surface 1132. The first surface 1131 and the second surface 1132 may be disposed opposite each other along a thickness direction of the mounting plate 113. Further, a portion of the first surface 1131 may be recessed toward the second surface 1132 to form a recess 1133. The recess 1133 may be configured to accommodate the air duct shell 114.

In particular, the air duct shell 114 may be reversibly disposed in the recess 1133. The air duct shell 114 may be connected to the recess 1133 by means of a rotary shaft, a hinge, or the like. The diversion air duct 111 may be formed inside the air duct shell 114. The accommodating spaces 112 may be disposed on the air duct shell 114. Furthermore, the accommodating space 112 may run through a side surface of the air duct shell 114 along a thickness direction of the air duct shell 114, and is thus in communication with the diversion air duct 111. In this way, the drying airflow in the diversion air duct 111 may act on the cleaning members 2 through the accommodating spaces 112. An avoidance opening 1133a is provided in a bottom wall of the recess 1133. The avoidance opening 1133a may provide clearance for the accommodating spaces 112 when the mounting plate 113 covers the air duct shell 114. The shape of the avoidance opening 1133a may be the same as the shape of the accommodating space 112. Alternatively, the dimension of the avoidance opening 1133a is larger than the dimension of the accommodating space 112.

It may be understood that the recess 1133 is formed in the mounting plate 113 to provide a receiving space for the air duct shell 114, such that the air duct shell 114 is reversibly disposed in the recess 1133, thereby facilitating mounting of the air duct shell 114 and the maintenance, service and other operations of an internal structure of the cleaning member drying module 10. The diversion air duct 111 is formed inside the air duct shell 114, and the accommodating spaces 112 run through the side surface of the air duct shell 114 along the thickness direction of the air duct shell 114 and are in communication with the diversion air duct 111, such that it is ensured that the drying airflow can smoothly flow through the diversion air duct 111 into the accommodating spaces 112, thereby ensuring the drying effect for the plurality of sets of cleaning members 2.

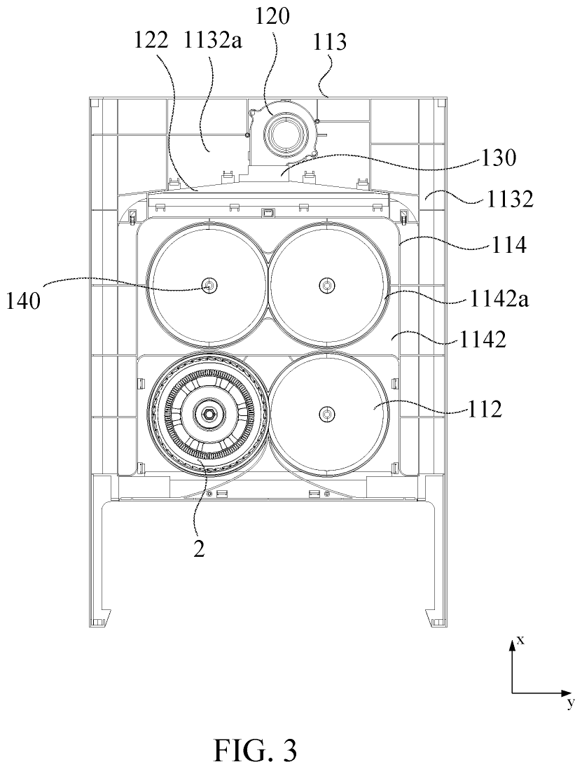

In a possible implementation, referring to FIGS. 3, 4, and 6, a mounting groove 1132a is provided in the second surface 1132 of the mounting plate 113. The airflow driving member 120 may be disposed in the mounting groove 1132a. The mounting groove 1132a may be disposed on one side of the recess 1133.

Further, the mounting groove 1132a and the recess 1133 may be distributed along a first direction. Furthermore, the mounting groove 1132a and the recess 1133 may be spaced apart by a side wall of the recess 1133. To enable circulation of the drying airflow, an air passage opening 1133b is provided in the recess 1133, and the air passage opening 1133b is configured for communication between the diversion air duct 111 and the fan air duct 121. In particular, the air passage opening 1133b may be disposed in a side wall of the recess 1133 facing the mounting groove 1132a. In an implementation, a plurality of air passage openings 1133b may be provided. The plurality of air passage openings 1133b may be spaced apart and distributed in the side wall of the recess 1133. The shape of the air passage opening 1133b may be circular, rectangular, oval, polygonal, or the like.

The first direction may refer to an X direction. Alternatively, the first direction may refer to a height direction of the cleaning base station 1.

It may be understood that the mounting groove 1132a and the recess 1133 are spaced apart by the side wall of the recess 1133, such that an independent receiving space may be provided for the airflow driving member 120, to prevent external interferences and ensure the stable operation of the airflow driving member. The air passage opening 1133b is provided to allow the diversion air duct 111 communicates with the fan air duct 121, such that the airflow generated by the airflow driving member 120 can smoothly enter the diversion air duct 111 through the air passage opening 1133b and is then distributed to the accommodating spaces 112, providing a continuous and stable airflow for drying the cleaning members 2.

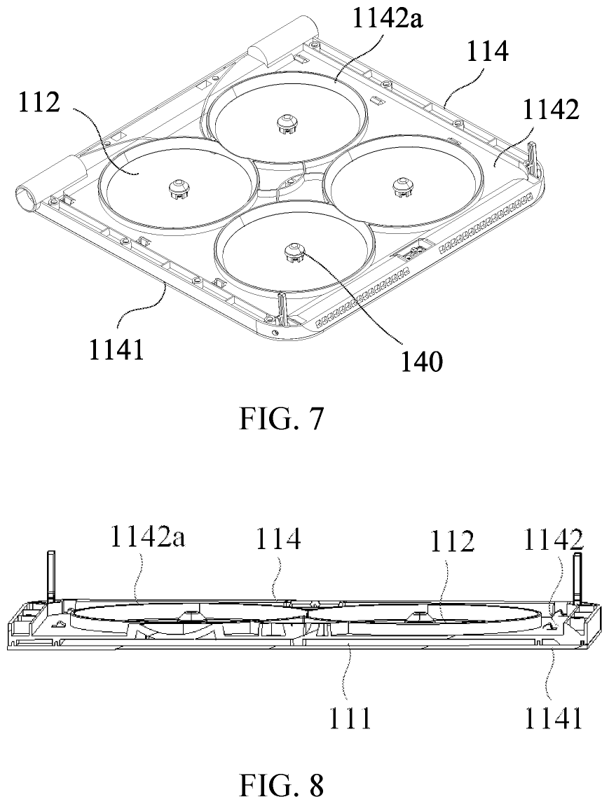

In a possible implementation, referring to FIGS. 1, 2, 3, 4, 7, and 8, the air duct shell 114 further includes a base plate 1141 and a partition plate 1142. The base plate 1141 may provide a support foundation for the air duct shell 114. The base plate 1141 may be adapted to the recess 1133 in shape, such that the air duct shell 114 can be properly positioned in the recess 1133. The partition plate 1142 may be fixedly disposed on one side of the base plate 1141. In particular, the partition plate 1142 is disposed on a side of the base plate 1141 facing the recess 1133. The partition plate 1142 is spaced apart from the base plate 1141, such that the partition plate 1142 and the base plate 1141 together define the diversion air duct 111. Further, a plurality of hollowed-out partition rings 1142a are further disposed on the partition plate 1142. The partition rings 1142a define the accommodating spaces 112 in an enclosing manner. In an implementation, each of the partition rings 1142a has a greater height than the cleaning members 2. A notch may be further disposed in the partition ring 1142a to facilitate user access to the cleaning members 2.

It may be understood that the base plate 1141 is configured to be adapted to the recess 1133 in shape such that the air duct shell 114 may be stably and properly mounted in the recess 1133, ensuring the stability of the air duct shell 114 during operation, avoiding waggling, displacement, and the like caused by unstable mounting, which otherwise influences the normal airflow circulation inside the cleaning member drying module 10. The hollowed-out partition rings 1142a define the accommodating spaces 112 in an enclosing manner, such that each accommodating space 112 for receiving the cleaning member 2 can be clearly delimited, ensuring that the cleaning members 2 do not interfere with each other during the drying process and reducing the influences of an unstable airflow on the drying process.

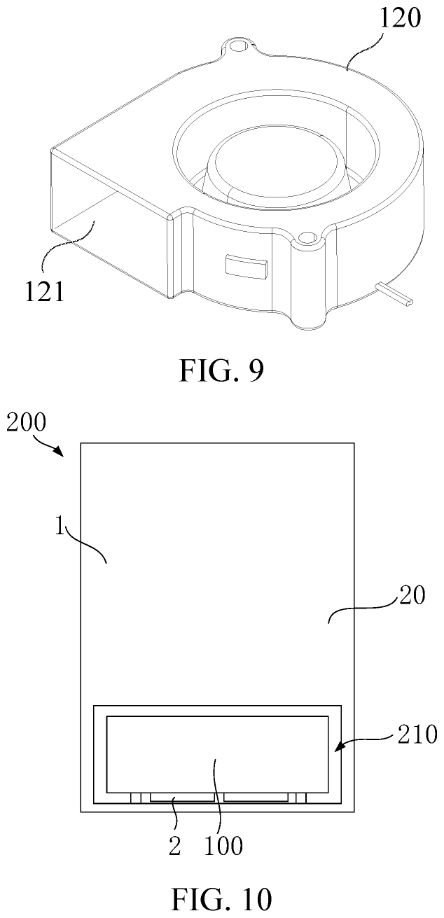

In a possible implementation, referring to FIGS. 1, 3, 4, 6, and 9, the diversion air duct 111 may have one or more inlets. In an implementation, along a second direction, an overall width of the inlet of the diversion air duct 111 is greater than a width of an outlet of the fan air duct 121. Further, the airflow driving member 120 further includes a diffusion nozzle 122. The diffusion nozzle 122 may be disposed at the outlet of the fan air duct 121. The diffusion nozzle 122 may define a diffusion air duct 1221. In particular, a flow area of the diffusion air duct 1221 gradually increases along the first direction and a direction from the airflow driving member 120 toward the recess 1133. The diffusion nozzle 122 is configured to gentle the airflow, avoiding turbulence caused by an excessive speed and a high impact force when the airflow directly enters the diversion air duct 111, thereby achieving a smooth transition from a high-speed concentrated airflow state to a relatively gentle and uniformly diffused state, and ensuring that the airflow can subsequently enter the diversion air duct 111 in a more orderly manner. The second direction may refer to a Y direction.

It may be understood that the width of the inlet of the diversion air duct 111 is greater than the width of the outlet of the fan air duct 121, and the diffusion nozzle 122 is provided at the outlet of the fan air duct 121 to form a diffusion air duct 1221, such that the flow area of the airflow in the direction from the mounting groove 1132a toward the recess 1133 can be gradually increased, thereby effectively reducing the airflow velocity and increasing the contact time between the airflow and the cleaning members 2, and thus ensuring more uniform distribution of the airflow to the cleaning member 2 in each accommodating space 112, which improves the drying efficiency and uniformity. Furthermore, a larger width of the inlet of the diversion air duct 111 is conducive to reducing pressure loss during airflow entry, improving the airflow transmission efficiency.

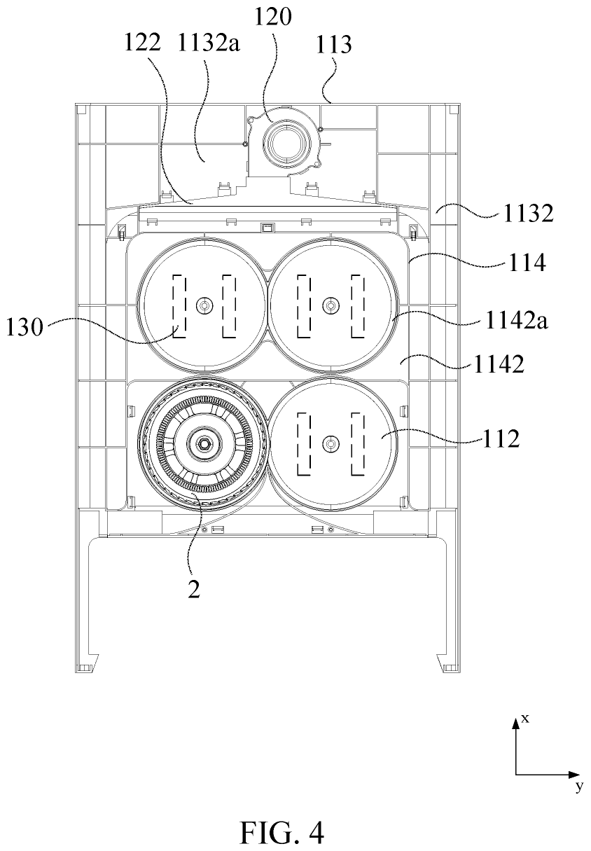

In a possible implementation, referring to FIGS. 3 and 4, the heater 130 is disposed within at least one of the fan air duct 121, the diversion air duct 111, the diffusion air duct 1221 and the accommodating space 112. In an implementation, the heaters 130 may be separately disposed in one of the fan air duct 121, the diversion air duct 111, the diffusion air duct 1221 or the accommodating space 112. Alternatively, the heaters 130 may be disposed in combination in at least two of the fan air duct 121, the diversion air duct 111, the diffusion air duct 1221 and the accommodating space 112. The arrangement and number of the heaters 130 may be determined according to actual requirements, and are not limited in the present application.

It may be understood that the heaters 130 are arranged at key nodes along the airflow path, and effective transfer and uniform distribution of thermal energy can be ensured, thereby achieving efficient heating of the airflow.

In particular, the heater 130 located in the fan air duct 121 may preheat the airflow at an early stage of airflow generation, increasing the initial temperature of the airflow. The heater 130 disposed in the diversion air duct 111 may further ensure that the airflow reaches a preset drying temperature before being distributed to the accommodating spaces 112, avoiding the problem of non-uniform temperature.

The heater 130 disposed in the diffusion air duct 1221 may maintain and optimize the temperature of the diverging airflow, ensuring that the airflow retains sufficient heat when entering the accommodating spaces 112. The heater 130 disposed in the accommodating space 112 may be in direct contact with the cleaning member 2, thereby providing localized intensified heating and accelerating moisture evaporation from the cleaning member 2. The multi-point heating design described above not only improves the drying efficiency and shortens the overall drying time, but also ensures that the cleaning members 2 are uniformly heated, avoiding the problem of incomplete drying caused by local overheating or insufficient heating. In addition, a rational layout of the heaters 130 also reduces energy waste and enhances the energy-saving and environmentally friendly properties of the cleaning base station 1.

In a possible implementation, referring to FIGS. 3 and 4, the heater 130 is fixed to at least one of the mounting plate 113, the air duct shell 114, the partition plate 1142 and the diffusion nozzle 122. In an implementation, the heaters 130 may be separately fixed to one of the mounting plate 113, the air duct shell 114, the partition plate 1142 or the diffusion nozzle 122. Alternatively, the heaters 130 may be fixed in combination to at least two of the mounting plate 113, the air duct shell 114, the partition plate 1142 and the diffusion nozzle 122. The arrangement and number of the heaters 130 may be determined according to actual requirements, and are not limited in the present application.

It may be understood that directly fixing the heaters 130 to key structural components can not only ensure the stability and durability of the heater 130, but also optimize the heat conduction path, enabling the heat to be transferred into the airflow more quickly and uniformly.

In particular, the heater 130 mounted on the mounting plate 113 may provide a stable heat source for the entire cleaning member drying module 10, ensuring that the airflow is sufficiently heated from the outset. The heater 130 fixed to the air duct shell 114 is conducive to maintaining the temperature of the airflow within the diversion air duct 111, ensuring temperature uniformity among the branch airflows. The heater 130 disposed on the partition plate 1142 may further increase the temperature during airflow distribution, avoiding uneven drying caused by temperature variations. The heater 130 located on the diffusion nozzle 122 may maintain the heat of the airflow during airflow diffusion, ensuring that the airflow entering the accommodating space 112 remains at an optimal drying temperature. This multi-point layout of the heaters 130 can improve thermal energy utilization efficiency and reduce energy loss.

In a possible implementation, referring to FIGS. 3 and 4, the heater 130 is disposed at least on a bottom wall of the accommodating space 112. In an implementation, the heater 130 may be in direct contact with the cleaning member 2, or a partition structure may be provided between the heater 130 and the cleaning member 2, such that the heat is conducted from the heater 130 to the cleaning member 2 via the partition structure. The partition structure may be part of the housing 110 (e.g., the base plate 1141). For example, the heater 130 is embedded inside the base plate 1141 and faces the accommodating space 112. Alternatively, the partition structure may be a cover, such as a film structure or a plate structure, disposed on the heater 130, with no limitation on the material of the partition structure and the specific method of fit between the partition structure and the housing 110.

In an implementation, one or more heaters 130 may be disposed on the bottom wall of each accommodating space 112. A plurality of heaters 130 may be evenly distributed on the bottom wall of the accommodating space 112. Alternatively, the plurality of heaters 130 may be distributed differentially in regions on the bottom wall of the accommodating space 112 to adapt to the airflow conditions in different regions of the accommodating space 112. Alternatively, the plurality of heaters 130 may be primarily distributed along edges of the bottom wall of the accommodating space 112 to accelerate moisture evaporation from edge portions of the cleaning member 2 and to prevent rapid heat loss from the edge portions of the cleaning member 2.

It can be understood that the heater 130 is disposed on the bottom wall of the accommodating space 112 and is in contact with the cleaning member 2 such that heat can be directly and efficiently conducted to the surface of the cleaning member 2, thereby accelerating moisture evaporation and shortening the drying time. The direct contact heating not only avoids the problem of non-uniform temperature but also provides consistent heat input to different portions of the cleaning member 2, thereby ensuring a comprehensive and uniform drying effect.

In a possible implementation, the heater 130 is at least one of a heater tube, a heater film, and a heater wire. In an implementation, the heater 130 may be one of a heater tube, a heater film or a heater wire. Alternatively, the heater 130 may be any two of a heater tube, a heater film and a heater wire. Alternatively, the heater 130 may be a heater tube, a heater film, or a heater wire.

During specific implementation, referring to FIGS. 3 and 4, the heater 130 may be a heater tube and may be disposed in the diffusion air duct 1221. Alternatively, the heater 130 may be a heater film attached to the bottom wall of the accommodating space 112 or disposed on an upper portion of the accommodating space 112. The heater film may be a polyimide heater film, a carbon fiber heater film, or the like. The heat generated by the heater film can act directly in the accommodating space 112 to provide the cleaning member 2 with thermal radiation, accelerating the drying of the cleaning member 2. Alternatively, the heater 130 may be a heater wire disposed on the bottom wall of the accommodating space 112 or disposed on the upper portion of the accommodating space 112. The heater wire may be a nickel-chromium alloy heater wire, an iron-chromium-aluminum alloy heater wire, a carbon fiber heater wire, or the like. The heater wire may be distributed in a spiral pattern, a square-loop pattern, a mesh pattern, or the like. The type and specific arrangement of the heater 130 may be combined in various ways, which are not limited in the present application. In practical applications, the type and arrangement of the heater 130 may be flexibly selected and combined depending on various considerations, such as the specific type of the cleaning member 2 (e.g., the material, dimension, shape, and other factors), the overall structure and spatial layout of the cleaning device 100, requirements of drying efficiency and uniformity, and cost control.

It may be understood that the above design can enhance the flexibility of the cleaning member drying module 10. By selecting different types of heaters 130, the thermal energy distribution can be optimized according to the requirements of specific application scenarios, ensuring that different portions of the cleaning member 2 can receive sufficient and uniform heat input.

In a possible implementation, referring to FIGS. 3 and 4, the dimension of the cleaning member 2 is smaller than the dimension of the accommodating space 112. In particular, a clearance exists between a peripheral wall of the cleaning member 2 and an inner side wall of the accommodating space 112. In an implementation, an assembly clearance between the peripheral wall of the cleaning member 2 and the inner side wall of the accommodating space 112 is equal to 3 mm. Alternatively, an assembly clearance between the peripheral wall of the cleaning member 2 and the inner side wall of the accommodating space 112 is greater than 3 mm.

It may be understood that a rational assembly clearance is provided to ensure that the airflow can circulate freely around the cleaning members 2, preventing airflow blockage or non-uniform distribution caused by a too small clearance, thereby increasing the coverage area and contact time of the airflow on the surface of the cleaning members 2 and enhancing the drying effect. In addition, the above assembly clearance can also reduce friction between the cleaning members 2 and the inner side walls of the accommodating spaces 112, thereby lowering the risk of wear of the cleaning members 2 during placement or removal, and extending the service life of the cleaning members 2 and the accommodating spaces 112.

In a possible implementation, the cleaning member 2 includes a cleaning cloth. In an implementation, the cleaning member 2 may be a cleaning sponge, a cleaning brush, or the like. A seal may be disposed on the inner side wall of the accommodating space 112. When the cleaning member 2 is located in the accommodating space 112, the seal may be in contact with the cleaning member 2. The seal may be a sealing strip, a silicone sealing pad, or the like. The seal can prevent excessive escape of the drying airflow from the accommodating space 112, thereby enhancing the drying effect.

It may be understood that, compared with other types of cleaning members 2, the cleaning cloth is easier to wash and dry, and can restore to a usable state within a shorter period of time, thereby shortening the overall cleaning cycle.

In a possible implementation, referring to FIGS. 1 and 2, the air duct shell 114 may be movably connected to the mounting plate 113. In particular, the air duct shell 114 is movable relative to the mounting plate 113 to open or close the diversion air duct 111.

It may be understood that the air duct shell 114 is designed to be movable relative to the mounting plate 113 such that the operational flexibility and maintenance convenience of the cleaning member drying module 10 can be enhanced. The air duct shell 114 is movable relative to the mounting plate 113, such that a user or the cleaning base station 1 can easily open or close the diversion air duct 111 according to actual requirements, thereby achieving control over the airflow path.

In some embodiments, the housing 110 is provided with a ventilation opening, the airflow driving member 120 is disposed upstream of the accommodating spaces 112 along the airflow path, and the airflow driving member 120 blows the airflow introduced into the fan air duct 121 from the ventilation opening, through the diversion air duct 111 to the accommodating spaces 112 for discharge. In particular, in this embodiment, the airflow driving member 120 and the heater may be disposed close to a start end of the entire airflow path (i.e., the ventilation opening), and the airflow driving member 120 and the heater 130 are located upstream of the accommodating spaces 112 along the airflow path. The airflow introduced through the ventilation opening first passes through the airflow driving member 120, then through the heater 130 and the diversion air duct 111, and is finally blown into the accommodating space 112 to heat and dry the cleaning member 2. Of course, in this embodiment, the specific arrangement of the ventilation opening and the airflow driving member 120 on the housing 110 are not limited. As such, the airflow driving member 120 may blow the airflow toward the accommodating spaces 112.

In some embodiments, the housing 110 is provided with a ventilation opening, the airflow driving member 120 is disposed downstream of the accommodating spaces 112 along the airflow path, and the airflow driving member 120 suctions the airflow introduced into the diversion air duct 111 from the ventilation opening, through the accommodating spaces 112 to the fan air duct 121 for discharge. In particular, in this embodiment, the airflow driving member 120 may be a negative-pressure fan or a suction fan. Along the airflow path, the heater 130 may be disposed close to the start end of the entire airflow path (i.e., the ventilation opening), and the airflow driving member 120 may be disposed close to a tail end of the entire airflow path. The heater 130 is located upstream of the accommodating space 112 along the airflow path, and the airflow driving member 120 is located downstream of the accommodating space 112 along the airflow path. Air introduced through the ventilation opening first passes through the heater 130 and the diversion air duct 111, then flows through the accommodating space 112 to heat and dry the cleaning member 2, and is finally discharged through the fan air duct 121. Of course, in this embodiment, the specific arrangement of the ventilation opening and the airflow driving member 120 on the housing 110 are not limited. As such, the airflow driving member 120 may suction the airflow into the accommodating spaces 112.

In some embodiments, a rotating support member 140 is disposed on a bottom wall of each of the accommodating spaces 112. The rotating support member 140 is rotatable relative to the housing 110, and the rotating support member 140 is adapted to drive the cleaning member 2 to rotate when the cleaning member 2 is disposed in the accommodating space 112 and is dried. The rotating support member 140 may fit with the cleaning member 2, such as a rigid framework of a cleaning cloth. As such, during the drying process, the rotating support member 140 drives the cleaning members 2 to rotate, which is conducive to uniform heating of the cleaning members 2, thereby improving the drying efficiency and drying effect.

Further, the present application provides a cleaning base station 1. Referring to FIGS. 1 and 2, the cleaning base station 1 includes a base station body 20 and the above cleaning member drying module 10. The base station body 20 is provided with a cleaning chamber 210. The cleaning chamber 210 can clean the cleaning device 100. The cleaning chamber 210 may be disposed on one side of the base station body 20 along a circumferential direction. The base station body 20 is further provided with a mounting space located on a peripheral side of the cleaning chamber 210. The mounting plate 113 of the cleaning member drying module 10 may be disposed in the mounting space. The air duct shell 114 of the cleaning member drying module 10 may be located on one side of the mounting plate 113. In particular, the air duct shell 114 may be located on a side of the mounting plate 113 facing away from the base station body 20.

It may be understood that the cleaning member drying module 10 is integrated into the base station body 20, thereby ensuring a compact and aesthetically pleasing structure of the cleaning base station 1. By means of the fixed position of the mounting plate 113, the cleaning member drying module 10 can be closely combined with the base station body 20, enhancing the overall structural stability and facilitating maintenance and service. In addition, the air duct shell 114 is located outside of the mounting plate 113. This may not only provide a smooth passage for an airflow, but also allow the air duct shell 114 to move relative to the mounting plate 113, such that the user or the cleaning base station 1 can open or close the diversion air duct 111, thereby optimizing the airflow path and simplifying the loading and unloading of the cleaning members 2.

In a possible implementation, referring to FIG. 1, the mounting space is provided with an air outlet 220. In an implementation, the air outlet 220 may be located on a side of the mounting space away from the airflow driving member 120 along the first direction. In an implementation, the overall area of the air inlet of the diversion air duct 111 is larger than the area of the air outlet 220.

It may be understood that a larger area of the air inlet is provided to ensure that the sufficient airflow can enter the diversion air duct 111, reducing pressure loss during airflow entry. The provision of a smaller area of the air outlet 220 contributes to creating a pressure difference before the airflow is discharged, enabling the airflow to be more uniformly distributed during passage through the cleaning members 2 and prolonging the residence time of the airflow within the accommodating spaces 112, thereby ensuring sufficient drying of the cleaning members 2.

Further, referring to FIG. 10, the present application provides a cleaning system 200, including a cleaning device 100 and the above cleaning base station 1. The cleaning device 100 is provided with removable cleaning members 2. The cleaning base station 1 may be configured to replace, wash, and dry the cleaning members 2 of the cleaning device 100. The cleaning device 100 may include a sweeping robot, a mopping robot, a floor washing machine, or the like. In an implementation, a transport mechanism may be further provided inside the cleaning base station 1. The transport mechanism may remove the cleaning member 2 from the cleaning device 100 by means of a corresponding mechanical structure (e.g., a clip or a suction cup) after the cleaning device 100 completes a cleaning task and returns to the cleaning base station 1. After removing the cleaning member 2, the transport mechanism may transfer the cleaning member 2 to a corresponding part in the cleaning base station 1. For example, the cleaning member 2 after use is transported to a washing tank for subsequent washing operations, or the cleaned but not dried cleaning member 2 is moved into the accommodating space 112 for the drying process. When the cleaning member 2 completes the washing and drying processes and is in a reusable state, the transport mechanism may mount the cleaning member onto the cleaning device 100 again.

It may be understood that the above design is conducive to achieving full-process management of washing, replacement and drying of the cleaning members 2, thereby simplifying the operation procedures for the user. The cleaning member drying module 10 of the cleaning base station 1 enables batch drying of the plurality of sets of cleaning members 2, effectively improving the drying efficiency. Batch drying of the plurality of sets of cleaning members 2 can reduce the total number of drying operations of the cleaning base station 1, thereby reducing the maintenance frequency and cost of the cleaning system 200.

The embodiments or implementations in this specification are described in a progressive manner, each embodiment focuses on the difference from other embodiments, and for the same or similar parts of the embodiments, reference can be made to each other.

It is to be noted that terms such as “one embodiment”, “embodiment”, “exemplary embodiment,” and “some embodiments” mentioned in this description may refer to embodiments that include particular features, structures, or characteristics, but not all embodiments necessarily include such particular features, structures, or characteristics. In addition, such phrases do not necessarily refer to the same embodiment. In addition, when the specific feature, structure, or characteristic is described with respect to an embodiment, it is within the knowledge of those skilled in the art to implement such a feature, structure or characteristic with respect to other embodiments, whether explicitly described or not.

In general, terms shall be understood at least in part depending on the use in the context. For example, at least in part depending on the context, the term “one or more” as used herein may be used to describe any single feature, structure or characteristic, or describe a combination of a plurality of features, structures or characteristics. Similarly, at least in part depending on the context, terms such as “a” or “the” may be understood as conveying either a singular meaning or a plural meaning.

It is to be readily understood that the terms “on”, “over”, and “above” in the present disclosure shall be interpreted in the broadest sense, such that “on” not only means “directly on something” but also includes the meaning of “on something” with intermediate features or layers therebetween, and “above” or “over” not only includes the meaning of “above” or “over something”, but may also include the meaning of “above” or “over something” without intermediate features or layers therebetween (i.e., directly on something).

Finally, it is to be noted that the above embodiments are merely intended to illustrate the technical solutions of the present application rather than limiting the present application. Although the present application has been described in detail with reference to the foregoing embodiments, it is to be understood by a person of ordinary skill in the art that modifications may be made to the technical solutions cited in the foregoing embodiments, or equivalent substitutions may be made to some or all of the technical features thereof, and such modifications or substitutions do not cause the essence of the corresponding technical solutions to depart from the scope of the technical solutions of the embodiments of the present application.

What is claimed is:

1. A cleaning member drying module for a cleaning base station, comprising:
a housing, wherein a diversion air duct is provided inside the housing, a plurality of accommodating spaces in communication with the diversion air duct are provided on the housing, and the accommodating spaces are configured to receive cleaning members of a cleaning device;
an airflow driving member disposed inside the housing, the airflow driving member having a fan air duct in communication with the diversion air duct; and
a heater disposed upstream of the accommodating spaces along an airflow path, the heater being configured to heat an airflow passing therethrough to form a drying airflow for drying the cleaning members.

2. The cleaning member drying module of claim 1, wherein the housing comprises:
a mounting plate comprising a first surface and a second surface opposite each other along a thickness direction, part of the first surface being recessed toward the second surface to form a recess; and
an air duct shell reversibly disposed in the recess, the diversion air duct being formed inside the air duct shell, and the accommodating spaces running through a side surface of the air duct shell along a thickness direction of the air duct shell to communicate with the diversion air duct,
wherein a clearance opening for providing clearance for the accommodating spaces is provided in a bottom wall of the recess.

3. The cleaning member drying module of claim 2, wherein a mounting groove is provided in the second surface of the mounting plate, the mounting groove and the recess being distributed along a first direction and spaced apart by a side wall of the recess;
the airflow driving member is disposed in the mounting groove; and
an air passage opening is provided in a side wall of the recess facing the mounting groove, and the diversion air duct communicates with the fan air duct via the air passage opening.

4. The cleaning member drying module of claim 2, wherein the air duct shell further comprises:
a base plate adapted to the recess in shape; and
a partition plate fixedly disposed on a side of the base plate facing the recess, the partition plate and the base plate together defining the diversion air duct, the partition plate having a plurality of hollowed-out partition rings, and the partition rings defining the accommodating spaces in an enclosing manner.

5. The cleaning member drying module of claim 4, wherein along a second direction, a width of an inlet of the diversion air duct is greater than a width of an outlet of the fan air duct; and
the airflow driving member further comprises a diffusion nozzle, wherein the diffusion nozzle is disposed at the outlet of the fan air duct, the diffusion nozzle defines a diffusion air duct, and a flow area of the diffusion air duct gradually increases along a first direction and a direction from the mounting groove toward the recess.

6. The cleaning member drying module of claim 5, wherein the heater is disposed in at least one of the fan air duct, the diversion air duct, the diffusion air duct and the accommodating spaces.

7. The cleaning member drying module of claim 5, wherein the heater is fixed to at least one of the mounting plate, the air duct shell, the partition plate and the diffusion nozzle.

8. The cleaning member drying module of claim 1, wherein the heater is disposed at least on a bottom wall of the accommodating space.

9. The cleaning member drying module of claim 1, wherein the heater is at least one of a heater tube, a heater film, and a heater wire.

10. The cleaning member drying module of claim 1, wherein an assembly clearance between a peripheral wall of each cleaning member and an inner side wall of each accommodating space is greater than or equal to 3 mm.

11. The cleaning member drying module of claim 1, wherein each of the cleaning members comprises a cleaning cloth.

12. The cleaning member drying module of claim 2, wherein the air duct shell is movable relative to the mounting plate to open or close the diversion air duct.

13. The cleaning member drying module of claim 1, wherein the housing has a ventilation opening, the airflow driving member is disposed upstream of the accommodating spaces along an airflow path, and the airflow driving member blows an airflow introduced into the fan air duct from the ventilation opening, through the diversion air duct toward the accommodating spaces for discharge.

14. The cleaning member drying module of claim 1, wherein the housing has a ventilation opening, the airflow driving member is disposed downstream of the accommodating spaces along an airflow path, and the airflow driving member suctions an airflow introduced into the diversion air duct from the ventilation opening, through the accommodating spaces to the fan air duct for discharge.

15. The cleaning member drying module of claim 2, wherein the housing has a ventilation opening, the airflow driving member is disposed downstream of the accommodating spaces along an airflow path, and the airflow driving member suctions an airflow introduced into the diversion air duct from the ventilation opening, through the accommodating spaces to the fan air duct for discharge.

16. The cleaning member drying module of claim 1, wherein a rotating support member is disposed on a bottom wall of each of the accommodating spaces, the rotating support member being rotatable relative to the housing, and the rotating support member being configured to drive the cleaning member to rotate when the cleaning member is disposed in the accommodating spaces and is dried.

17. The cleaning member drying module of claim 2, wherein a rotating support member is disposed on a bottom wall of each of the accommodating spaces, the rotating support member being rotatable relative to the housing, and the rotating support member being configured to drive the cleaning member to rotate when the cleaning member is disposed in the accommodating spaces and is dried.

18. A cleaning base station, comprising:
a base station body, wherein a cleaning chamber configured to clean a cleaning device is provided on one side of the base station body along a circumferential direction, and the base station body is further provided with a mounting space located on a peripheral side of the cleaning chamber; and
the cleaning member drying module of claim 1, wherein a mounting plate of the cleaning member drying module is fixedly disposed in the mounting space, and an air duct shell of the cleaning member drying module is located on a side of the mounting plate facing away from the base station body.

19. The cleaning base station of claim 18, wherein the mounting space has an air outlet, and an area of an air inlet of the diversion air duct is greater than an area of the air outlet.

20. A cleaning system, comprising:
a cleaning device having removable cleaning members ; and
the cleaning base station of claim 19, the cleaning base station being configured to replace, wash, and dry the cleaning members of the cleaning device.
